(19) United States
(12) Patent Application Publication
(10) Pub. No.: US 2002/0059384 A1
(43) Pub. Date: May 16, 2002

(54) Substituting URL for attachment in forwarding electronic content

(75) Inventor: Peter Bernhard Kaars, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/900,335

(22) Filed: Jul. 5, 2001

Related U.S. Application Data
(60) Provisional application No. 60/218,271, filed on Jul. 13, 2000.

(51) Int. Cl. G06F 15/16

(52) U.S. Cl. 709/206

(57) ABSTRACT

A service on a data network verifies if an attachment to a sender's e-mail has a copy of an electronic document available from a source on the data network If the document is available from this source, the service strips the attachment from the e-mail body and replaces it with a URL to save bandwidth and storage space.

### FIELD OF THE INVENTION

The invention relates to sending or distributing electronic content over a data network, e.g., the Internet. The invention relates in particular to e-mail communication.

### BACKGROUND ART

Trends indicate that so-called viral distribution is going to play an important role in the delivery of content over the Internet. With “viral distribution” is meant a mechanism wherein the content is propagating and spreading into a community of end-users, much in the same way as a virus. The idea is that there is no explicit distribution channel. The content is passed on from user to user, e.g., content being distributed by youngsters sending e-mails. Napster is another example wherein a server provides a table of contents so that users can pick-up copies from other users'PC's. One form of this mechanism is that users find a piece of content somewhere on the Web and send it by e-mail to a friend. In the case of music files or, especially, video files attached to e-mails the size of the message and hence the bandwidth usage can be significant. Typically, the attachment contains a file of a popular artist or hit movie.

### SUMMARY OF THE INVENTION

The inventor proposes to reduce bandwidth usage in this form of viral distribution. To this end, the e-mail's attachment is reviewed, e.g., by the mail server or a dedicated email program on the sender's PC, before it is being sent to the addressee. The purpose of the review is to determine whether or not the attachment is a well-known piece of content that is available from many sources, e.g., from a server much closer to the target user (addressee). If so, the attachment is replaced by a much smaller pointer. The server of the target user recognizes the pointer and attaches a local copy of the relevant media file before delivering it to the target user. Alternatively, the attachment is replaced automatically by the pointer altogether, and the recipient is to retrieve the file using this pointer. A further embodiment of the invention uses verifying, either on the sending server or receiving server, whether the source user is authorized to distribute the relevant media file. If not, the file can be replaced by a message to the target user, or the e-mail can bounce back to the source user with a warning message, or the source user can be offered the option to pay for the option to distribute, or the target user can be offered the option to pay.

An aspect of the invention relates to a method of controlling communication of content information from a user to a sender as mentioned above, wherein the communication is conditionally being carried out depending on the sender being authorized to communicate the content information, and/or depending on the receiver being authorized to receive the content information. As the content information has to be identified anyway to enable a search on the availability of the content from another source, the identification process can be used to verify if the sender and/or receiver are authorized to send and/or receive the content. Restrictions to the distribution of content may apply in view of, e.g., copyright protection or content ratings. As to ratings, some content is considered unsuitable for minors. If the receiver has an email account he/she may have a profile, e.g., created at the time of registering, that indicates some types of content are not to be forwarded to this person.

Another aspect of the invention relates to Instant Messaging (IM). A user who has installed an IM program is set up for a communications service that enables to create a private chat room with another individual. A chat room is a channel that creates a peer-to-peer communication data path, e.g., for text messaging or (PC) video conferencing. Typically, the instant messaging system alerts the user whenever another individual on the user's private chat list is online. The user can then initiate a chat session with that particular individual. Streaming files in an IM (i.e., real time) context is rather undesirable as the streaming file makes a great demand on the communication bandwidth. Rather than streaming the file, it is more convenient to forward or have forwarded the pointer to the file that the receiver can use to download or stream it from another source.

### BRIEF DESCRIPTION OF THE DRAWING

The invention is explained below in further detail, by way of example and with reference to the accompanying drawing, wherein

FIG.1 is a flow diagram of operations in a method of the invention; and

FIG.2 is a block diagram of a system in the invention.

### DETAILED EMBODIMENTS

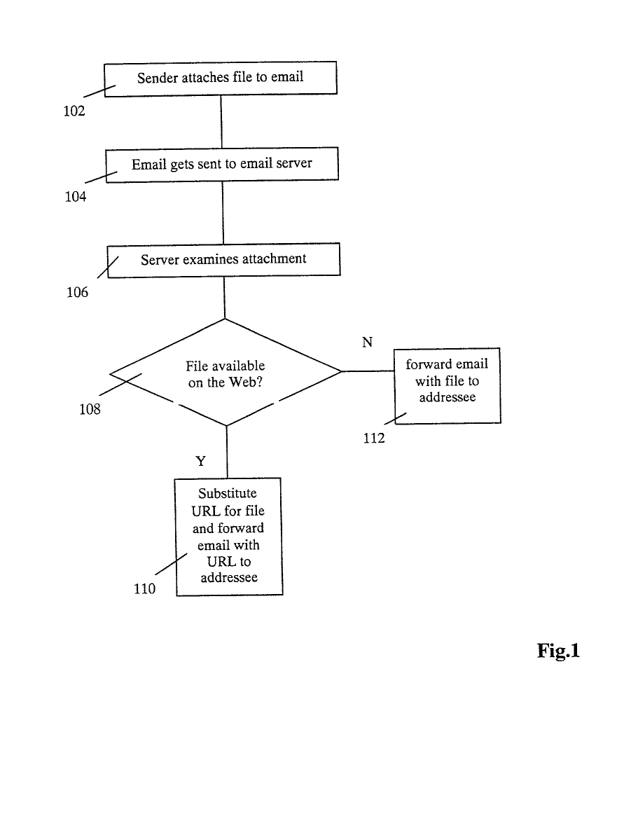

FIG.1 is a flow diagram with operations in a method of the invention. In step 102, the user prepares an e-mail and attaches a file to it. The file comprises, e.g., an MP3 clip or another electronic document. In step 104, the email is sent to the addressee and gets to the email server first. In step 106, the server analyses the attachment. For example, the file extension determines the type of file (e.g., an extension “.mp3” indicates an MP3 file; an extension “.mpg” indicates an MPEG file; an extension “.avi” indicates an AVI file; etc.). Typically, such a file has a header describing the content. Note that the user may copy the file from the Web and rename it for his/her own docketing purposes. The server analyses this header and checks an index, either created on the fly or in advance, if the file is available from another source on the Web. Alternatively, the server checks the file for an embedded watermark or other unique identifier, or uses another process to identify the file's content (e.g., waveform matching, fingerprinting) in order to find a listed copy. If the file is available from another source, the email body gets sent to the addressee in step 110 with a URL or another pointer substituting the file. The URL or other pointer identifies the source on the Web for the same file that the sender had attached. If the server cannot locate a source on the Web for the file, the email gets forwarded to the addressee as composed by the sender.

As to watermarking and fingerprinting (also referred to as “hashing”), these are well known technologies for authenticating audio or video content. A watermark is a signal or pattern embedded in the audio or video content. A watermark is difficult to remove, if possible at all. A watermark is conserved under common audio and video operations, such as D/A and A/D conversion, filtering or compression. Watermarks are generally detectable only by appropriate software. Watermarks enable to identify the content, its origin, the transmission path, its author, owner, the usage rights, and authorized users of the watermarked content. Whereas watermarking affects the content itself, fingerprinting leaves the content intact but creates an identifier that is unique for that piece of content. Typically, a fingerprint is computed using a hash algorithm applied to the digital content.

Preferably, the server's index gets updated with the information about the file analyzed, preferably in a background process. For example, the server may temporarily hold the file in a cache if the server was not able to find a source on the Web and it updates the index accordingly. Alternatively, if the index did not have an existing pointer to the appropriate resource on the Web and the server finds one, the latter is added to the server's index.

Above substitution of the pointer for the file may be an automatic process. Alternatively, the sender may indicate to the server that he/she would like to have the server substitute a pointer for the attachment if possible, so as to save bandwidth. A service provider may provide a discount of the service cost charged to this particular sender if the option of substitution is selected. Also, the receiver or addressee may indicate to his/her service provider that a pointer is preferred over the content as attachment, if possible, so as to reduce bandwidth and storage space.

An aspect of the invention could also be embodied by software residing at the end-user's PC. The software cooperates with the local email program. Upon detecting an attachment to an email, the software makes an attempt to determine if the content information of the attachment is publicly available on the Web, and if so, to locate a URL or set of URLs. For example, the software instructs via a browser a search engine to determine a location of the content information and return a list of URLs. When found, the attachment is detached from the email and one or more URLs are substituted before the email leaves the user's PC.

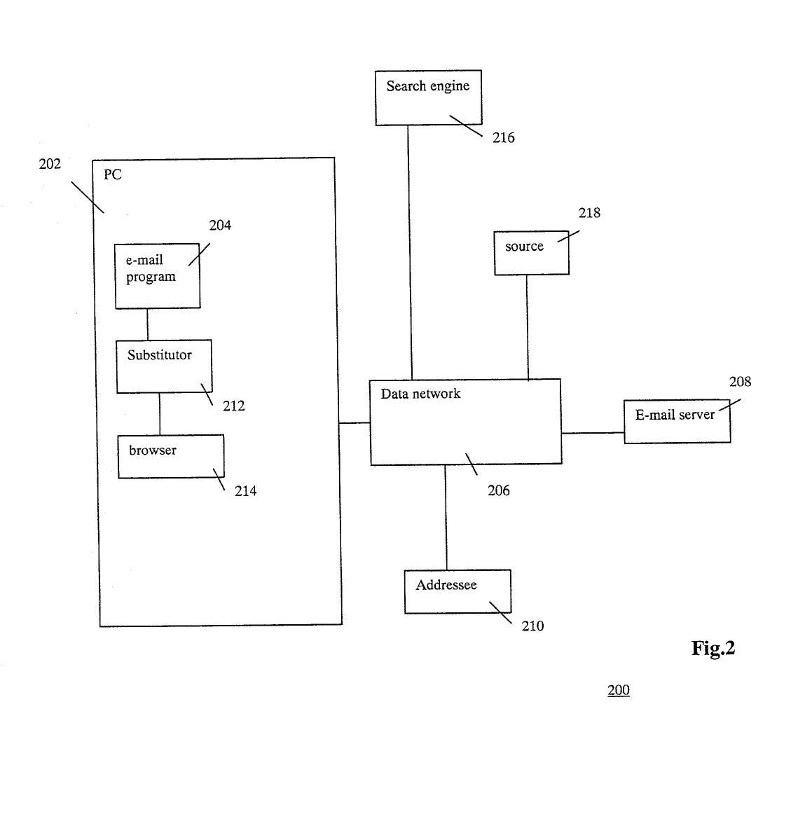

FIG.2 is a block diagram of a system 200 in the invention illustrating this aspect. System 200 comprises a PC 202 of an e-mail subscriber. PC 202 has an e-mail application 204 that enables the user to send an e-mail via a data network 206 and an e-mail server 208 to an addressee 210. PC 202 further comprises substitution software 212 and a browser 214. Substitution software 212 analyzes e-mails created by the user of PC 202 to determine if electronic documents are attached to the e-mail to be sent. If an attachment is found and identified, software 212 instructs browser 214 to contact a search engine 216 to find out if the same electronic document is available from a source on data network 206. Assume that search engine 216 has available an index that lists a source 218 as having an exact copy of the electronic document that the user has attached to the e-mail body. Browser 214 gets returned from search engine 216 a pointer (e.g., a URL) of source 218, and notifies software 212. Software 212 then strips attachment from the e-mail, or otherwise cuts the bonds between the e-mail and the attachment, and substitutes the pointer. Then the e-mail is ready to be sent to addressee 210. Upon receipt of the e-mail, addressee opens the e-mail and retrieves the copy of the document via the pointer embedded.

Incorporated by reference herein:

U.S. Ser. No. 09/642,713 (attorney docket US 000213) filed Aug. 21, 2000 for Leila Kaghazian for SELECTIVE SENDING OF PORTIONS OF ELECTRONIC CONTENT. This document relates to enabling a user of a handheld communication device to select in a foreground process portions of an electronic document. In a background process a new document is prepared that comprises the selected portions. The user selects the address for forwarding the new document, and the new document gets sent in a background process.

U.S. Ser. No. 09/374,694 (attorney docket PHA 23,737) filed Aug. 16, 1999 for Chanda Dharap for SEMANTIC CACHING. This document relates to caching resources based on the semantic type of the resource. The cache management strategy is customized for each semantic type, using different caching policies for different semantic types. Semantic types that can be expected to contain dynamic information, such as news and weather, employ an active caching policy wherein the resource in the cache memory is chosen for replacement based on the duration of time that the resource has been in cache memory. Conversely, semantic types that can be expected to contain static resources, such as encyclopedic information, employ a more conservative caching strategy, such as LRU (Last Recently Used) and LFU (Least Frequently Used) that is substantially independent of the time duration that the resource remains in cache memory. Additionally, some semantic types, such as communicated e-mail messages, newsgroup messages, and so on, may employ a caching policy that is a combination of multiple strategies, wherein the resource progresses from an active cache with a dynamic caching policy to a more static caches with increasing less dynamic caching policies. The relationship between semantic content type and caching policy to be associated with the type can be determined in advance, or may be determined directly by the user, or could be based, at least partly, on user-history and profiling of user-interaction with the resources.

U.S. Ser. No. 09/844,570 (attorney docket US 018052) filed Apr. 4, 2001 for Eugene Shteyn for DISTRIBUTED STORAGE ON A P2P NETWORK ARCHITECTURE. This document relates to a network architecture for, e.g., a cable operator to enable a broadband service, such as a video-on demand service, in a peer-to-peer network environment. The network uses high-speed reliable data network connections between service provider hubs or proxies, e.g., cable operators local stations. The end-users form a peer-to-peer network community around each hub. The peer-to-peer network provides distributed storage for content downloaded from the hub that is only a few hops away. The content is stored locally using community resources and is made available to the community via a Virtual Private Web service. This service enables content look-up, content distribution, connection set-up, copyright protection, and other facilities. Current peer-to-peer (P2P) solutions provide low or undefined (video) quality of content, cannot guarantee a timely content delivery, and do not have proper copyright protection in place for the content. An aspect of the invention provides a scalable service, e.g., for VOD, that overcomes these drawbacks. The invention also enables a business model where the VOD service can be provided inexpensively and with high quality. Low cost of the service may further deter content piracy, which is usually associated with peer-to-peer networking.

What is claimed is:

1. A method of controlling communication of content information from a sender to a receiver via a data network, the method comprising:
verifying if the content information is available from a source other than the sender; and
if the content information is available from the other source, substituting for the content information a pointer to the other source.

2. The method of claim 1, being carried out on request of at least the sender or the receiver.

3. The method of claim 1, wherein the verifying comprises identifying the content based on a watermark embedded in the content.

4. The method of claim 1, wherein the verifying comprises identifying the content based on a fingerprint of the content.

5. The method of claim 1, wherein the communication is conditionally being carried out depending on the sender being authorized to communicate the content information.

6. The method of claim 1, wherein the communication is conditionally being carried out depending on the receiver being authorized to receive the content information.

7. Software for cooperation with an email application, the software verifying if an attachment to a specific email to be sent is available from the Web.

8. Software for cooperation with an Instant Messaging application, the software verifying if a file to be sent by a user via a data network is available from a source on the data network independent of the user.
